(19) United States
(12) Patent Application Publication
(10) Pub. No.: US 2026/0099521 A1
(43) Pub. Date: Apr. 9, 2026

(54) INFORMATION PROCESSING APPARATUS, STORAGE MEDIUM, AND INFORMATION PROCESSING METHOD

(71) Applicant: CANON KABUSHIKI KAISHA, Tokyo (JP)

(72) Inventor: TOSHIO OHASHI, Tokyo (JP)

(21) Appl. No.: 19/349,826

(22) Filed: Oct. 3, 2025

(30) Foreign Application Priority Data
Oct. 7, 2024 (JP) 2024-176191

(51) Int. Cl. G06F 16/3329

(52) U.S. Cl. CPC G06F 16/33295

(57) ABSTRACT

An information processing apparatus includes a receiving unit configured to receive a prompt from a user, the received prompt being natural language, an acquisition unit configured to acquire, from a cloud service, device information regarding devices corresponding to an organization to which the user belongs, and a display unit configured to display an answer generated by a language model based on the received prompt and the acquired device information on a display section.

### BACKGROUND

### Field of the Technology

The present disclosure relates to an information processing apparatus, a storage medium, and an information processing method.

### Description of the Related Art

Generative artificial intelligence (AI) accesses Microsoft Graph®, web information, a database, a plugin, or the like in response to a prompt input by a user and performs preprocessing termed grounding.

The generative AI is a mechanism where the generative AI searches for specific information related to the input prompt, adds, to the prompt, the information obtained by the search, and inputs the prompt to a large language model, whereby the user can obtain a more practical answer.

Japanese Unexamined Patent Application Publication No. 2023-543268 describes a technique for answering a question if a user inputs a question in natural language to a chat bot operating on a server that performs machine learning.

When a user asks generative AI a question regarding a device, and if device information regarding the device entered as part of an input prompt is vague, a general answer that is not well correlated to the target device may be given, and the user may not obtain an appropriate answer regarding the target device. However, in order for the user to obtain an appropriate answer, the user needs to input natural language that allows the identification of the target device. Thus, input a prompt is cumbersome.

### SUMMARY

According to an aspect of the present disclosure, an information processing apparatus includes a receiving unit configured to receive a prompt from a user, the received prompt being natural language, an acquisition unit configured to acquire, from a cloud service, device information regarding devices corresponding to an organization to which the user belongs, and a display unit configured to display an answer generated by a language model based on the received prompt and the acquired device information on a display section.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating examples of a system configuration and a hardware configuration according to a first embodiment.

FIG. 2 is a diagram illustrating an example of a software configuration according to the first embodiment.

FIGS. 3A and 3B are diagrams illustrating examples of table configurations according to the first embodiment and a second embodiment.

FIGS. 4A and 4B are diagrams illustrating an example of an app manifest of a plugin application according to the first embodiment and a third embodiment.

FIGS. 5A and 5B are flowcharts illustrating an example of processing when an answer is generated according to the first embodiment.

FIG. 6 is a diagram illustrating an example of a screen displayed when an answer is generated according to the first embodiment.

FIG. 7 is a diagram illustrating examples of a system configuration and a hardware configuration according to the second embodiment.

FIG. 8 is a diagram illustrating an example of a software configuration according to the second embodiment.

FIG. 9 is a flowchart illustrating an example of processing when an answer is generated according to the second embodiment.

FIG. 10 is an example of a screen displayed when an answer is generated according to the second embodiment.

FIG. 11 is a diagram illustrating examples of a system configuration and a hardware configuration according to the third embodiment.

FIG. 12 is a diagram illustrating an example of a software configuration according to the third embodiment.

FIGS. 13A to 13D are diagrams illustrating examples of table configurations according to the third embodiment.

FIG. 14 is a flowchart illustrating an example of processing when an answer is generated according to the third embodiment.

FIG. 15 is an example of a screen displayed when an answer is generated according to the third embodiment.

### DESCRIPTION OF THE EMBODIMENTS

Embodiments for carrying out the present disclosure will be described below with reference to the drawings.

### First Embodiment

An embodiment of a support system using generative artificial intelligence (AI) according to the present disclosure is described. The description is given is an example of the support system a device management service and a generative AI service that operate on a cloud. In a first embodiment, the description is also given is a multifunction peripheral (MFP) as an example of a device as a target of the support system. Examples of the device also include image forming apparatuses and image processing apparatuses other than an MFP, such as a printer, a fax, a projector, and the like.

A generative AI cloud 120 and a client computer 140 are examples of an information processing apparatus and a control apparatus, respectively. The support system according to the present disclosure can be used not only for an inquiry about a device but also for an inquiry about a service.

In the present application, “generative AI” refers to a technique for using methods of deep learning and machine learning to automatically generate a variety of content such as text, an image, music, video, and the like similar to those created by people.

In the present embodiment, the official name of a product or a service is described as an example of natural language input that allows the identification of a device as a target. The natural language input that allows the identification of the target device is not limited to the official name, and may be the popular name or the model number of the product or the service, a keyword, or the like. The natural language input is not limited so long as the natural language input allows the identification of the target device.

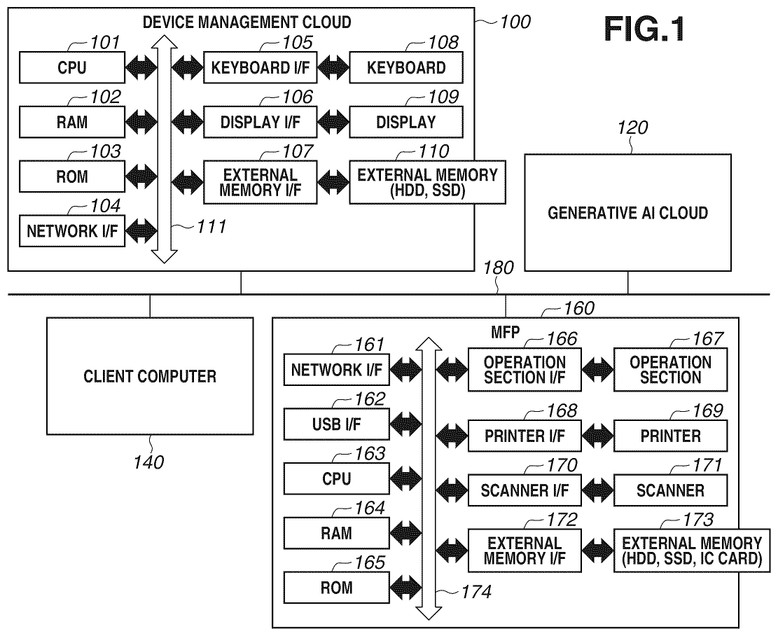

FIG. 1 is a block diagram illustrating examples of the system configuration and the hardware configuration of a support system according to the present embodiment.

The support system includes a device management cloud 100, a generative AI cloud 120, a client computer 140, and an MFP 160 that are connected together via a network 180. The configurations of general-purpose computers that achieve the device management cloud 100 and the generative AI cloud 120 are achieved, for example, using hardware resources supplied on demand by a virtualization technique. Alternatively, the device management cloud 100 and the generative AI cloud 120 may be servers. The client computer 140 has the configuration of a general-purpose computer.

In the device management cloud 100, a central processing unit (CPU) 101 executes processes such as control, calculation, and the like based on application programs and the like stored in a read-only memory (ROM) 103 or an external memory 110. CPU is the abbreviation of central processing unit. ROM is the abbreviation of read-only memory.

Further, the CPU 101 performs overall control of devices connected to a system bus 111. Based on commands issued using a mouse cursor (not illustrated) or the like on a display 109, the CPU 101 opens various registered windows and executes various types of data processing. The display 109 functions as a display section. The display 109 may further function as an operation section. The CPU 101 may execute processes based on input provided not only through the mouse cursor but also through a keyboard 108.

A random-access memory (RAM) 102 functions as a main memory, a work area, or the like for the CPU 101. RAM is the abbreviation of random-access memory. The ROM 103 is a read-only memory that functions as a storage area for a basic input/output (I/O) program and the like. I/O is the abbreviation of input/output and means input and output. The ROM 103 or the external memory 110 stores an operating system program (hereinafter “OS”), which is a control program for the CPU 101, and the like. Further, the ROM 103 or the external memory 110 stores files and various other pieces of data used in the processes based on the application programs and the like.

A network interface (I/F) 104 connects to the network 180 and performs network communication.

This enables the CPU 101 to communicate with an external apparatus via the network I/F 104. A keyboard I/F 105 controls input from the keyboard 108 and a pointing device (not illustrated). A display I/F 106 controls display on the display 109. An external memory I/F 107 controls access to and from the external memory 110 such as a hard disk drive (HDD), a solid-state drive (SSD), or the like. The external memory 110 stores a variety of pieces of data such as a boot program, various applications, a user file, an editing file, and the like.

The device management cloud 100 operates in the state where the CPU 101 is executing the basic I/O program and the OS written in the ROM 103 or the external memory 110. The basic I/O program is written in the ROM 103, and the OS is written in the ROM 103 or the external memory 110. Then, when the computer is powered on, the OS is written from the ROM 103 or the external memory 110 into the RAM 102 by an initial program load function in the basic I/O program, and the operation of the OS is started.

The system bus 111 connects devices, and this enables components to communicate with each other. Hardware resources such as the CPU 101, the ROM 103, the external memory 110, and the like included in the device management cloud 100 are supplied on demand by the virtualization technique. These hardware resources are supplied on demand by the virtualization technique, whereby the device management cloud 100 is configured as a virtual server in a cloud computing environment.

The hardware configurations of the generative AI cloud 120 and the client computer 140 are similar to that of the device management cloud 100, and therefore are not described.

In the MFP 160, a network I/F 161 connects to the network 180 and performs network communication. A Universal Serial Bus (USB) I/F 162 directly connects to the client computer 140 and performs communication. The MFP 160 supports both connection methods for a network connection via the network I/F 161 and a USB connection via the USB I/F 162.

Based on a control program and the like, a CPU 163 outputs an image signal as output information to a printer 169 via a printer I/F 168 connected to a system bus 174.

The control program is stored in a ROM 165, an external memory 173, or the like. The CPU 163 is configured to perform a communication process with each computer via the network I/F 161 or the USB I/F 162. Further, the CPU 163 executes processes based on application programs and the like stored in the ROM 165 or the external memory 173.

A RAM 164 functions as a main memory, a work area, or the like for the CPU 163 and is configured to expand the memory capacity using an optional RAM connected to an additional port (not illustrated). The RAM 164 is used as an output information loading area, an environment data storage area, a non-volatile random-access memory (NVRAM), or the like. The ROM 165 is a read-only memory that functions as a storage area for a basic I/O program and the like.

The external memory 173 corresponds to an HDD, an SSD, an integrated circuit (IC) card, or the like and stores a variety of pieces of data such as a boot program, various applications, a user file, an editing file, and the like. The ROM 165 or the external memory 173 stores the control program for the CPU 163, the application programs, font data used to generate the output information, information used in the MFP 160, and the like.

An operation section I/F 166 controls an interface with an operation section 167 and outputs image data that can be displayed to the operation section 167. The operation section I/F 166 also receives information input through the operation section 167 by a user. The operation section 167 corresponds to an operation panel in which a switch for an operation, a light-emitting diode (LED) display device, and the like are disposed, a touch panel, or the like. The operation section 167 transmits information input by the user to the operation section I/F 166. The operation section 167 may include a keyboard and a display. In the present embodiment, the operation section 167 includes a display section such as a display, a touch panel, or the like and displays various screens and various pieces of information.

The printer I/F 168 outputs an image signal (an example of output information) to the printer 169 (a printer engine). A scanner I/F 170 receives an image signal (an example of input information) from a scanner 171 (a scanner engine).

An external memory I/F (memory controller) 172 controls access to the external memory 173 such as an HDD, an SSD, an IC card, or the like. The above external memory is not limited to a single external memory. At least one or more external memories may be included, and a plurality of external memories may be configured to be connected. The above external memory can also be excluded from the configuration if not necessary. Further, the MFP 160 may include an NVRAM (not illustrated) and store printer mode setting information from the operation section 167. The system bus 174 connects devices, and this enables components to communicate with each other.

In this system, any numbers of device management clouds 100, generative AI clouds 120, client computers 140, and MFPs 160 can be connected, and a plurality of device management clouds 100, a plurality of generative AI clouds 120, a plurality of client computers 140, and a plurality of MFPs 160 may be connected. The present embodiment assumes that a plurality of MFPs 160 is connected to the network 180.

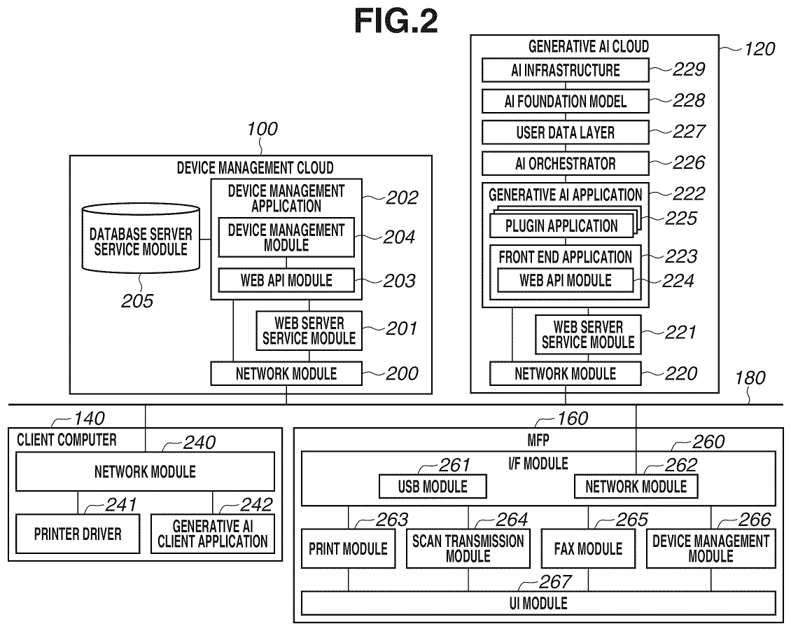

FIG. 2 is a block diagram illustrating an example of the software configuration of the support system according to the present embodiment.

First, the software configuration of the device management cloud 100 is described. The functions of the pieces of software are executed under control of the CPU 101 of the device management cloud 100.

In the device management cloud 100, a device management application 202 and modules are saved and managed, for example, in the external memory 110. The save locations of the device management application 202 and the modules are not limited to the external memory 110, and may be another storage medium or the like. Alternatively, a configuration may be employed in which the device management application 202 and the modules are saved outside the device management cloud 100 and accessed, when necessary, whereby the pieces of software are used.

These modules are program modules that are loaded into the RAM 102 and executed by the OS or a module that uses the modules when the modules are executed. The device management application 202 can be added to the HDD or the SSD as the external memory 110 supplied on demand by the virtualization technique in the cloud computing environment.

A network module 200 performs network communication with the generative AI cloud 120 and the MFP 160 using any communication protocol.

A web server service module 201 provides a service that, if the service receives a Hypertext Transfer Protocol (HTTP) request, returns an HTTP response. The web server service module 201 may request the device management application 202 to generate an HTTP response. HTTP is the abbreviation of Hypertext Transfer Protocol and is a type of communication protocol.

The device management application 202 is an application that manages MFPs 160 connected to the device management cloud 100 via the network 180. For example, the device management application 202 is implemented as a program that executes processing in response to a request to a web application programming interface (API) provided by the web server service module 201. API is the abbreviation of application programming interface.

As described above, the device management application 202 achieves, with the web server service module 201, a cloud service that manages MFPs 160. In the device management application 202, a web API module 203 calls each module as needed according to a request from the web server service module 201 and generates an HTTP response.

A exemplary description of a device management module 204 as the module called by the web API module 203. As a matter of course, the web API module 203 may call a module other than the device management module 204.

The device management module 204 acquires, via the network module 200, device information and logs from the MFPs 160 connected to the device management cloud 100 via the network 180. Any communication protocol can be used to acquire the device information and the logs from the MFPs 160. Examples of the communication protocol used by the device management module 204 include Hypertext Transfer Protocol Secure (HTTPS) and the like.

The device management module 204 stores the device information acquired from modules of the MFPs 160 in a device management table 300 or a log management table 301 in a database server service module 205. The device management module 204 also extracts (acquires) the device information from the device management table 300 or the log management table 301 as needed.

The database server service module 205 manages data and stores and extracts data according to a request from another module. The database server service module 205 may be present in a device different from the device management cloud 100 so long as the database server service module 205 can be accessed by the device management application 202. The database server service module 205 may be a database service in the cloud computing environment.

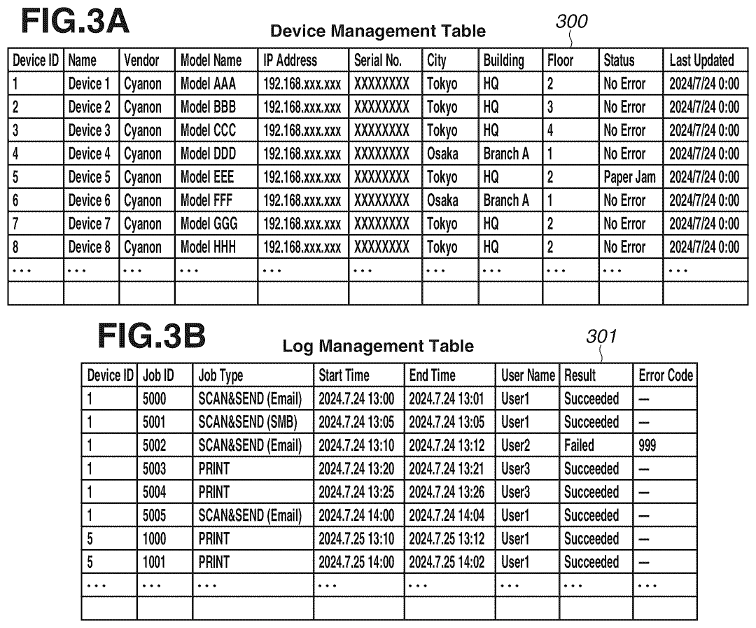

FIGS. 3A and 3B illustrate examples of table configurations in the database server service module 205. FIG. 3A illustrates a device management table 300, and FIG. 3B illustrates a log management table 301. The table configurations in FIGS. 3A and 3B are merely examples, and table configurations different from these examples may be employed. The device management table 300 is a table that manages the device information regarding the MFPs 160 managed by the device management application 202. In the present embodiment, “device information” refers to a variety of pieces of information regarding a device, such as the model name and the like, as illustrated in the device management table 300.

Examples of the information managed in the device management table 300 include a device identifier (Device ID), a device/model name (Name), a vendor name (Vendor), a model name (Model Name), an Internet Protocol (IP) address (IP Address), and the like. Besides, examples of the information include a serial number (Serial No.), installation location information (City, Building, Floor), a status (Status), a last update date and time (Last Updated), and the like.

The device identifier (Device ID) is an identifier uniquely identifying each MFP 160. The installation location information (City, Building, Floor) is an address, a building name, floor information, and the like indicating the installation location of the MFP 160. The status (Status) is information indicating the state of the MFP 160. The last update date and time (Last Updated) indicates the last update date and time when the record is updated based on information acquired from the MFP 160.

The log management table 301 is a table that stores the logs acquired from the MFPs 160 by the device management module 204. Examples of the information managed in the log management table 301 include a device identifier (Device ID), a job identifier (Job ID), a job type (Job Type), and the like. Besides, examples of the information include a job execution start date and time (Start Time), a job execution end date and time (End Time), a job execution username (User Name), a job execution result (Result), a job execution result error code (Error Code), and the like.

A “job” refers to a processing work such as print, scan transmission, fax, or the like that can be executed by the user on each MFP 160. The job identifier (Job ID) is an identifier uniquely identifying each job. The job execution result error code (Error Code) is a code for uniquely identifying the cause of an error in the job.

Next, referring back to FIG. 2, an example of the software configuration of the generative AI cloud 120 is illustrated. The functions of the pieces of software are achieved under control of the CPU 101 of the generative AI cloud 120. Applications and modules included in the generative AI cloud 120 are saved and managed in the external memory 110.

These modules are program modules that are loaded into the RAM 102 and executed by the OS or a module that uses the modules when the modules are executed. The applications included in the generative AI cloud 120 can be added to the HDD or the SSD as the external memory 110 supplied on demand by the virtualization technique in the cloud computing environment.

A network module 220 performs network communication with the device management cloud 100 and the client computer 140 using any communication protocol. A web server service module 221 provides a service that, if the service receives an HTTP request from a generative AI client application 242 of the client computer 140, returns an HTTP response. The web server service module 221 may request a generative AI application 222 to generate an HTTP response.

The generative AI application 222 is an artificial intelligence system application that generates a response to a user input such as characters or the like in cooperation with an AI orchestrator 226, an AI foundation model 228, an AI infrastructure 229, and the like. For example, the generative AI application 222 is implemented as a program that executes processing in response to a request to a web API provided by the web server service module 221.

As described above, the generative AI application 222 achieves a cloud service for generative AI with the web server service module 221.

In the generative AI application 222, a front-end application 223 receives an input from the user, generates a response in cooperation with the AI orchestrator 226, the AI foundation model 228, the AI infrastructure 229, and the like, and returns the response. In the front-end application 223, a web API module 224 calls each module as needed according to a request from the web server service module 221 and generates an HTTP response.

The generative AI application 222 can be extended, enhanced, and customized by adding the knowledge, the skill, and the experience of generative AI. As one of the methods for extending the functions of the generative AI application 222, there is a plugin mechanism for extending the skill by communicating with an external web service using natural language input.

A plugin application 225 is an application that adds a particular function to the generative AI application 222 using the plugin mechanism of the generative AI application 222. The plugin application 225 according to the present embodiment calls a web service of the device management application 202 on the device management cloud 100, thereby achieving the function of managing MFPs 160. Then, the plugin application 225 adds the function of managing MFPs 160 to the generative AI application 222 using the plugin mechanism of the generative AI application 222.

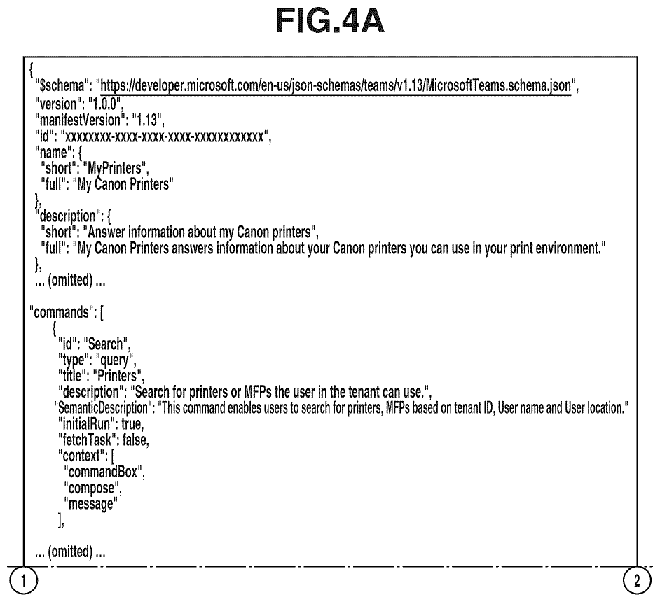

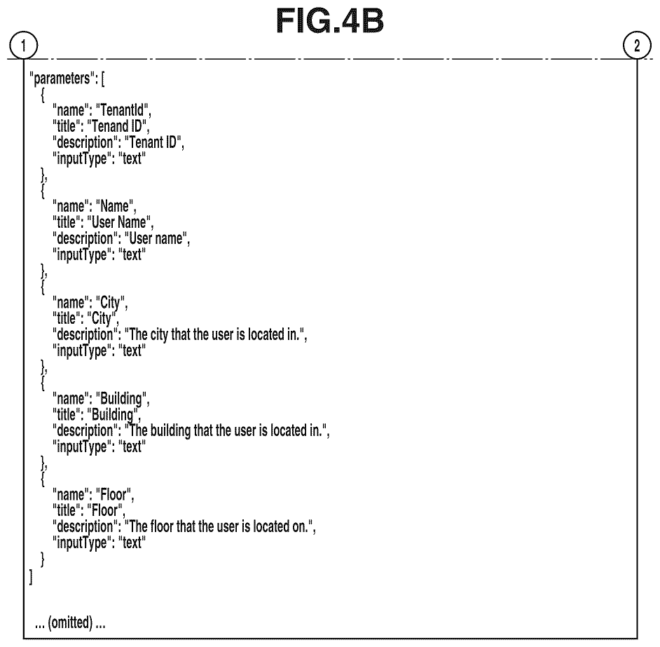

The plugin application 225 is composed of an app manifest including the description of the application in natural language, and the like. FIGS. 4A and 4B illustrate an example of the implementation of the app manifest of the plugin application 225 according to the present embodiment. The app manifest states that the plugin application 225 is an application having the skill of providing information regarding MFPs 160, printers, and the like that can be used by the user in a user environment. The app manifest also describes commands to call cooperation partner web services, and parameters when the web services are called.

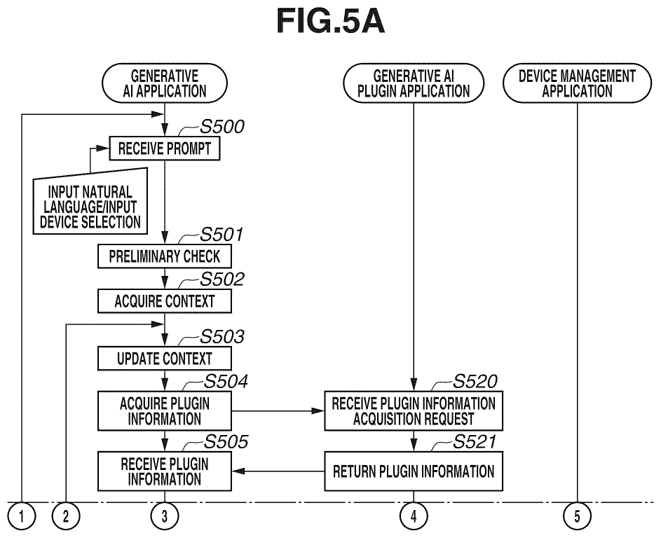

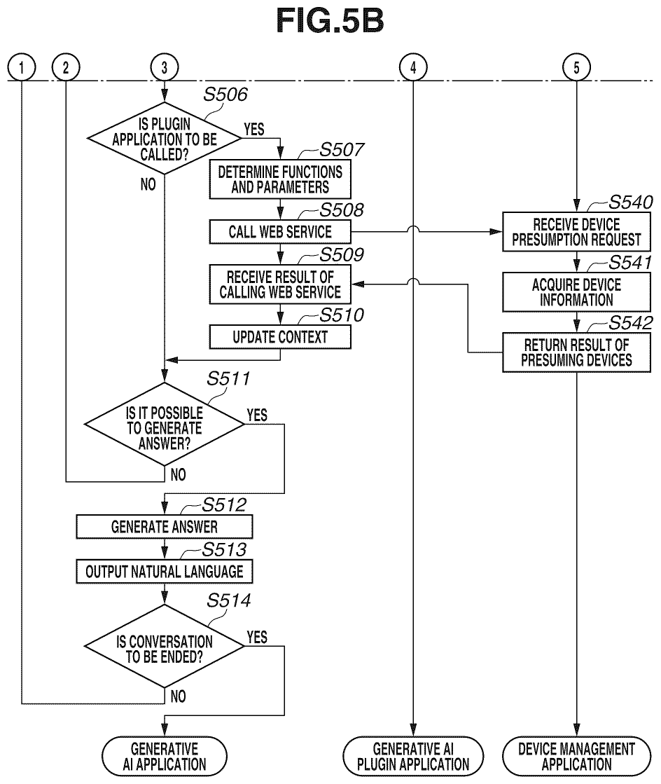

By processing described below with reference to FIG. 5A an 5B, based on the content of this app manifest, a plugin having a skill suitable for the generation of an answer to an input of the user is selected, and a command is executed.

Referring back to FIG. 2, during the period from the input of natural language by the user to the output of natural language (an answer), the AI orchestrator 226 operates in the background and performs business logic control such as the selection and the execution of a plugin suitable for the generation of an answer and the like.

A user data layer 227 saves user data and provides a method for accessing the user data. The user data is information associated with the login account of the user, and for example, is the email address of the user, calendar information, a team to which the user belongs, a colleague, a file that can be accessed, and the like. The AI foundation model 228 is composed of a generative AI model such as a large language model (LLM) or the like. The AI infrastructure 229 sets and manages a cloud and a graphics processing unit (GPU) corresponding to the infrastructure of the generative AI cloud 120.

Next, an example of the software configuration of the client computer 140 is illustrated. The functions of the pieces of software are achieved under control of the CPU 101 of the client computer 140. Modules included in the client computer 140 are saved and managed in the external memory 110. These modules are program modules that are loaded into the RAM 102 and executed by the OS or a module that uses the modules when the modules are executed.

A network module 240 performs network communication with the generative AI cloud 120 and the MFP 160 using any communication protocol. A printer driver 241 generates a print job and transmits the print job to the MFP 160 via the network module 240.

The printer driver 241 receives the execution result of the print job performed by the MFP 160 via the network module 240, and the reception result is displayed on the display 109 of the client computer 140. A generative AI client application 242 transmits an HTTP request message to the generative AI cloud 120 and receives an HTTP response message from the generative AI cloud 120 via the network module 240.

The received HTTP response message is displayed on the display 109 of the client computer 140. The client computer 140 accesses the generative AI cloud 120 through the generative AI client application 242.

Next, an example of the software configuration of the MFP 160 is illustrated. The functions of the pieces of software of the MFP 160 are achieved under control of the CPU 163 of the MFP 160. In the MFP 160, various modules are saved and managed in the ROM 165 or the external memory 173 and loaded into the RAM 164 and executed when the various modules are executed.

An I/F module 260 communicates with the device management cloud 100 and the client computer 140 using any communication protocol through use of a USB module 261 or a network module 262. The USB module 261 directly connects to the client computer 140 and communicates with the client computer 140. The network module 262 connects to the network 180 and performs network communication.

The MFP 160 supports both connection methods for a USB connection via the USB module 261 and a network connection via the network module 262 and can switch connection methods based on a device setting.

A print module 263 receives, via the I/F module 260, a print job transmitted from the printer driver 241 of the client computer 140 and executes the print job. The print module 263 also creates a log of the execution result of the print job and saves the log in a device management module 266.

A scan transmission module 264 receives a scan instruction from the user through a user interface (UI) module 267 and generates and executes a scan job and a transmission job for scan data. To transmit the scan data, for example, a protocol such as an email protocol, Server Message Block (SMB), or the like is used. The scan transmission module 264 creates logs of the execution results of the scan job and the transmission job and saves the logs in the device management module 266.

A fax module 265 receives, via the network module 262, a fax job transmitted from a fax apparatus, an MFP (not illustrated), or the like. Regarding a fax reception job received at this time, printing is executed via the print module 263, or the fax reception job is transferred to another fax apparatus, another MFP, or the like via the network module 262. Additionally, the fax module 265 receives a fax transmission instruction from the user through the UI module 267 and generates and executes a fax transmission job. The fax module 265 also creates logs of the execution results of the fax reception job and the fax transmission job and saves the logs in the device management module 266.

The device management module 266 manages device information regarding the MFP 160. The device management module 266 receives an acquisition request to acquire the device information from the device management module 204 of the device management cloud 100 via the network module 262 and returns the device information. The device management module 266 also receives a log acquisition request from the device management module 204 of the device management cloud 100 and returns a log of the execution result of a job via the network module 262. The UI module 267 draws a UI to be displayed on the operation section 167 of the MFP 160 and receives a user input value input by the user operating a UI on the operation section 167.

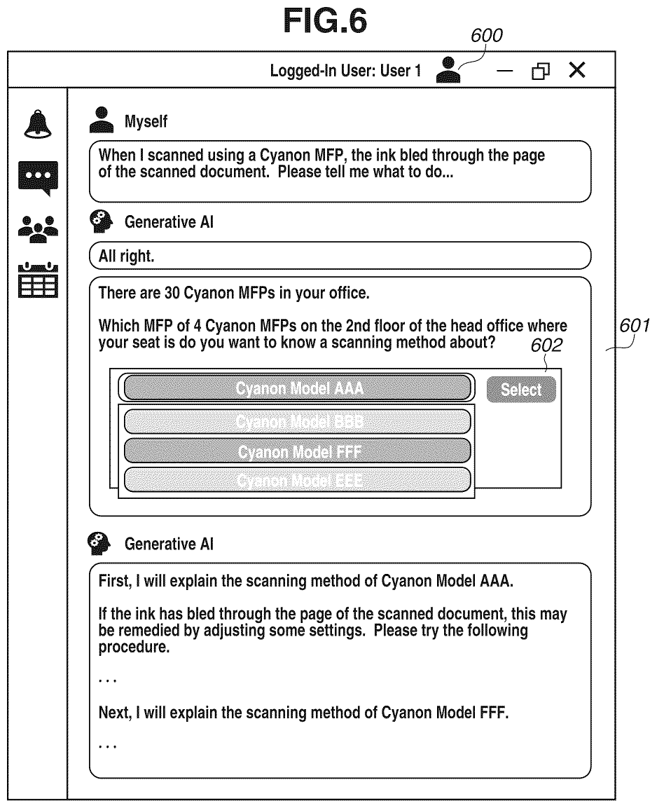

Next, with reference to FIGS. 5A and 5B, a description is given of an example of an operation in which the generative AI cloud 120 receives a prompt regarding the MFP 160 input by the user and answers the prompt. At the same time, with reference to FIG. 6, an example of the display of a screen of the generative AI client application 242 displayed to the user is illustrated. FIG. 6 is a diagram illustrating an example of a screen generated by the generative AI client application 242 controlled by the CPU 101 of the client computer 140 in the present embodiment. This screen is displayed on the display 109 of the client computer 140. Alternatively, a configuration may be employed in which this screen is displayed on the operation section 167 of the MFP 160. In this case, an answer generated by the language model based on the following processing is displayed on the operation section 167 of the MFP 160.

FIGS. 5A and 5B are flowcharts illustrating an example of a series of processes until the generative AI answers a prompt in the present embodiment. This operation is started using as a trigger the input of a prompt regarding the MFP 160 on the generative AI client application 242 by the user.

The software 220 to 229 of the generative AI cloud 120 operates by being executed by the CPU 101 of the generative AI cloud 120. The software 201 to 205 of the device management cloud 100 operates by being executed by the CPU 101 of the device management cloud 100.

In step S500, the front-end application 223 of the generative AI application 222 receives the prompt from the generative AI client application 242. The “prompt” refers to an instruction sentence input using natural language on the generative AI client application 242 by the user. That is, the front-end application 223 receives the prompt in the natural language from the user. The prompt is adjusted as needed and is input to the LLM. In the present embodiment, an example is taken where the user inputs a prompt with a content, such as “I have attempted scan transmission of a printed document on the MFP 160, but the scan transmission has failed, so I want to perform troubleshooting”, without specifying the official name of the MFP 160. The input prompt is not limited to a prompt regarding troubleshooting regarding scan transmission of a printed document.

In the example of the display of the screen in FIG. 6, a logged-in username 600 is displayed, and a prompt area 601 displays the content of the prompt input by the user and an answer from the generative AI. The user logs into the generative AI application 222 or an account for cooperating with the generative AI application 222. An account for logging into the client computer 140 or the MFP 160 may be the same as the generative AI application 222 or the account for cooperating with the generative AI application 222.

In step S501, the front-end application 223 checks the prompt input in step S500 in terms of fairness, reliability, safety, privacy, security, comprehensiveness, transparency, accountability, and the like. If the check of the prompt regarding any of these items fails, the conversation ends, and this operation also ends. At this time, for example, a warning such as “The conversation ends because the check has failed”, “The prompt is not appropriate”, or the like may be displayed.

If the check of the prompt by the front-end application 223 is successful, the processing proceeds to step S502.

In step S502, the AI orchestrator 226 acquires a context. The context refers to information indicating the context, the background, the situation, and the like related to the conversation of the user. Specifically, for example, the context is a variety of pieces of information such as information regarding the user, e.g., a language used by the user or the like, information regarding a page accessed on the generative AI client application 242 by the user or currently displayed information, and the like.

In step S503, the AI orchestrator 226 updates the context based on user data acquired from the user data layer 227. The update of the context refers to the execution of the process of newly adding information to the context acquired in step S502, the process of organizing the context, both these processes, or the like. Then, the AI orchestrator 226 adjusts the prompt based on the updated context and transmits the adjusted prompt to the LLM of the AI foundation model 228. For example, the adjustment of the prompt refers to the removal of a banned word or the editing of the prompt to obtain a context easily interpreted by the LLM, and this adjustment is not an essential process. The AI orchestrator 226 receives a response to the transmitted prompt from the LLM.

In step S504, the AI orchestrator 226 requests a plugin application 225 to acquire plugin information. This is performed to identify a plugin application 225 capable of acquiring device information to answer the prompt input by the user. Thus, if a plurality of plugin applications 225 is managed, normally, the AI orchestrator 226 requests all the plugin applications 225 to acquire plugin information. If a plugin application 225 capable of acquiring device information can be identified to answer the prompt input by the user, it is not necessary to request all the plugin applications 225 to acquire plugin information.

In step S520, the plugin application 225 receives the plugin information acquisition request from the AI orchestrator 226. In step S521, the plugin application 225 returns plugin information including an app manifest to the AI orchestrator 226. In step S505, the AI orchestrator 226 receives the plugin information returned from the plugin application 225. By this process, the AI orchestrator 226 acquires the plugin information.

In step S506, based on the description of the app and commands written in the app manifest of the plugin application 225, the AI orchestrator 226 determines whether to call the plugin application 225. If the AI orchestrator 226 receives plugin information from a plurality of plugin applications 225, the AI orchestrator 226 further determines which of the plugin applications 225 is to be called. If the AI orchestrator 226 determines that the plugin application 225 is to be called (YES in step S506), the processing proceeds to step S507. If the AI orchestrator 226 determines that the plugin application 225 is not to be called (NO in step S506), the processing proceeds to step S511.

In the case of the present embodiment, the input prompt is a question regarding the MFP 160, but does not include the official name of the device, and therefore, it is assumed that a plugin application 225 having the function of managing MFPs 160 is called to identify the device. That is, it is assumed that it is determined that the input prompt does not include information required to identify the device as the target. If a method for certainly calling a plugin application 225 having the function of managing MFPs 160 in response to a question regarding the MFP 160 is used, the AI orchestrator 226 may perform control other than the above.

In step S507, the AI orchestrator 226 inputs the prompt input by the user, the updated context, and the information regarding the plugin application 225 to the LLM of the AI foundation model 228. Based on a response to the input information from the LLM, the AI orchestrator 226 acquires functions and parameters for calling a web service declared by the plugin application 225.

In step S508, using the functions and the parameters acquired in step S507, the AI orchestrator 226 calls the web service declared by the plugin application 225. In step S540, the web service is called, whereby the device management application 202 of the device management cloud 100 receives a device presumption request. Then, in step S541, the device management application 202 acquires device information regarding MFPs 160 stored in the device management table 300 in the database server service module 205 via the device management module 204.

In the present embodiment, the device management cloud 100 performs filtering using position information included in the device information. Specifically, the device management cloud 100 selectively acquires the device information regarding only an MFP 160 regarded as physically close to the user among MFPs 160 belonging to (corresponding to) an account corresponding to an organization to which the user belongs. For example, the organization is a corporation such as a company to which the user works for or the like. In the present embodiment, the device management cloud 100 also manages the location of the user's seat. FIG. 6 illustrates an example where the user's seat is the second floor of the head office. Alternatively, position information regarding an information processing apparatus such as a personal computer or the like used by the user may be found out based on a network to which the information processing apparatus is connected or the like, and the position information regarding the user may be used when the filtering is performed.

As a matter of course, an MFP 160 as a target may be filtered using information other than the physical distance from the user. For example, the device information may be acquired by filtering an MFP 160 based on a device state, a function included in the device, vendor information regarding the device, a priority set in advance, or the like.

Alternatively, the device information may be acquired by filtering an MFP 160 based on a use frequency, usage history, or the like using log information stored in the log management table 301 in the database server service module 205. Alternatively, the device information may be acquired by filtering only an MFP 160 highly correlated to a prompt inquiry, for example, by preferentially selecting an MFP 160 in which trouble corresponding to the content of a prompt inquiry occurs frequently (the number of inquiries about trouble is great).

In step S542, the device management application 202 returns the device information regarding the MFPs 160 acquired in step S541 to the AI orchestrator 226. The filtering may be performed by transmitting the device information regarding the MFPs 160 stored in the device management table 300 to the AI orchestrator 226 and then selecting necessary information in the generative AI cloud 120.

In step S509, the AI orchestrator 226 receives the device information returned from the device management cloud 100. That is, the AI orchestrator 226 acquires the device information corresponding to the organization to which the user belongs. In step S510, the AI orchestrator 226 updates the context based on the device information received in step S509. As described above, according to the present disclosure, the prompt is received from the user in step S500, whereby it is possible to acquire the device information without receiving an instruction to acquire the device information.

In step S511, the AI orchestrator 226 determines whether it is appropriate to generate an answer. If it is determined that it is appropriate to generate an answer (YES in step S511), the processing proceeds to step S512. If it is determined that it is not appropriate to generate an answer (NO in step S511), the processing returns to step S503. In step S503, the AI orchestrator 226 continuously repeats the inference by the LLM.

In step S512, the AI orchestrator 226 inputs all the information collected in the above processing to the LLM of the AI foundation model 228 and causes the LLM to generate an answer. That is, the AI orchestrator 226 inputs the information regarding the prompt, the context, and the like to the LLM, thereby causing the LLM to generate an answer. In the present embodiment, the LLM generates an answer based on the prompt received in step S500 and the device information acquired in step S509. Then, the AI orchestrator 226 checks the answer generated by the LLM in terms of fairness, reliability, safety, privacy, security, comprehensiveness, transparency, accountability, and the like.

In step S513, the AI orchestrator 226 returns the final response to the front-end application 223. The front-end application 223 returns the answer to the generative AI client application 242. As a result, the generative AI client application 242 displays the answer. Consequently, the answer generated based on the prompt received in step S500 and the device information acquired in step S509 is displayed.

In the example of the display of the screen in FIG. 6, the prompt area 601 displays an answer from the generative AI that indicates in natural language that there are 30 MFPs 160 in the user environment, and four MFPs 160 are present on the second floor of the head office where the user's seat is. Then, options 602 for devices display information regarding the four MFPs 160 present on the second floor of the head office where the user's seat is, and the user can select one or more MFPs 160. The prompt area 601 displays a plurality of options including the devices corresponding to the device information acquired in step S509.

As described above, in step S541, the device management application 202 acquires the device information by selecting only an MFP 160 physically close to the user. Thus, as a result, the options 602 for devices displayed here display MFPs 160 physically close to the user. Using this information, the MFPs 160 are displayed in ascending order of the distance between each MFP 160 and the client computer 140.

Alternatively, for example, if the device information is acquired by filtering an MFP 160 using the device state, the options 602 for MFPs 160 in any device states are displayed based on the acquired device information. If the device information is acquired by filtering an MFP 160 using the function included in the device, the vendor information regarding the device, the priority set in advance, or the like, the options 602 for MFPs 160 having any functions, MFPs 160 of any vendors, or MFPs 160 having high priorities are displayed. That is, the options 602 are displayed according to priorities set by the user.

If the device information is acquired by filtering an MFP 160 based on the use frequency, the usage history, or the like, the options 602 for frequently used MFPs 160 or recently used MFPs 160 are displayed based on the acquired device information. That is, the options 602 are displayed in descending order of the use frequency of each device. If the device information is acquired by filtering an MFP 160 highly correlated to a prompt inquiry, the options 602 for MFPs 160 in which trouble corresponding to a prompt inquiry occurs frequently are displayed based on the acquired device information. That is, the options 602 are displayed in descending order of the number of inquiries made about each device.

The display of the options 602 is not essential. For example, a configuration may be employed in which the user identifies a device as a target by another method such as inputting the name of the device or information corresponding to the device. Alternatively, for example, a configuration may be employed in which if only a single device corresponds to the user or the account of the user, or there is a plurality of the same models, the processing proceeds without receiving the specifying of a device by selection from the options 602 from the user, and an answer is displayed.

At this time, the device information regarding the identified device may be displayed, and for example, the user may respond YES or NO to the display of an answer “Is this model OK?”, whereby a handling method for the device may be displayed as an answer. Alternatively, an answer may include an image. If an answer includes both text (a character string) and an image, usability improves.

In step S514, the front-end application 223 determines whether to end the conversation. If the user selects any of the options 602 corresponding to MFPs 160 and selects a “select” button, the front-end application 223 determines that the conversation is to be continued (NO in step S514), and the processing returns to step S500. That is, if the user selects a device from the displayed options 602, the frontend application 223 receives the selected device. At this time, information regarding the MFP 160 selected by the user is the prompt in step S500, and the front-end application 223 receives the prompt. At this time, specifically, the device information corresponding to the device (the option) selected by the user is treated as the prompt. For example, the information identified by the user selecting the device is the official name of the MFP 160. Alternatively, the information may be the model number, the serial number, the version information, or the like.

Then, in steps S501 to S513, the inference by the LLM is continuously repeatedly performed again, and the final answer from the LLM is displayed in the prompt area 601. Consequently, based on the information regarding the selected MFP 160, the user can obtain an answer having the content of troubleshooting when scan transmission fails.

On the other hand, if the user starts a new conversation on the generative AI client application 242 or ends the generative AI client application 242, then in step S514, the front-end application 223 determines that the conversation ends (YES in step S514), and the processing ends.

By the above processing, the generative AI cloud 120 identifies a device as a target using acquired device information and inputs information based on the device information regarding the identified device to the LLM, thereby causing the LLM to create an answer. As a result, without inputting the official name of the target device, the user can obtain an appropriate answer equivalent to that in a case where the official name of the target device is input. As a specific example, if the user inputs a question about troubleshooting regarding a device to a prompt in step S500, the LLM generates an answer to the question about troubleshooting in step S512. The answer to the question about troubleshooting refers to an answer indicating processing that can be executed by the MFP 160.

Although in the present embodiment, a description has been given based on a product, namely the MFP 160, the present disclosure is not limited to this. For example, the present disclosure exerts an effect also on a service of an application or the like. Without inputting not only the official name but also natural language that allows the identification of the device as the target, the user can obtain an appropriate answer equivalent to that in a case where the natural language that allows the identification of the device as the target is input.

Although in the present embodiment, an example has been illustrated where a prompt input by the user and an updated context are input to the LLM, the present disclosure is not limited to this. For example, a configuration may be employed in which the AI orchestrator 226 adds information regarding a context or the like to a prompt, inputs a prompt composed of a variety of pieces of information including a prompt input by the user to the LLM, and obtains an answer.

Although in the present embodiment, the LLM is managed by the generative AI cloud 120, the present disclosure is not limited to this. The LLM may operate on another server. In this case, the CPU 101 transmits the prompt received in step S500 and the device information acquired in step S509 to the server and receives via the network I/F 104 an answer generated by the LLM according to the transmission of the prompt and the device information. Consequently, the answer is ultimately displayed on the display section.

### Second Embodiment

In the first embodiment, an example has been illustrated where the generative AI cloud 120 accesses a web service of the device management cloud 100 using the plugin mechanism, thereby acquiring information regarding MFPs 160 connected to the network 180. In a second embodiment, an example is illustrated where even if MFPs 160 are not connected to the network 180, the generative AI client application 242 acquires device information regarding MFPs 160 directly connected to the client computer 140.

Although in the present embodiment, as examples of the MFPs 160 directly connected to the client computer 140, MFPs 160 USB connected to the client computer 140 are illustrated, a direct connection method other than a USB connection, such as Wi-Fi Direct communication, Bluetooth® communication, or the like, may be used.

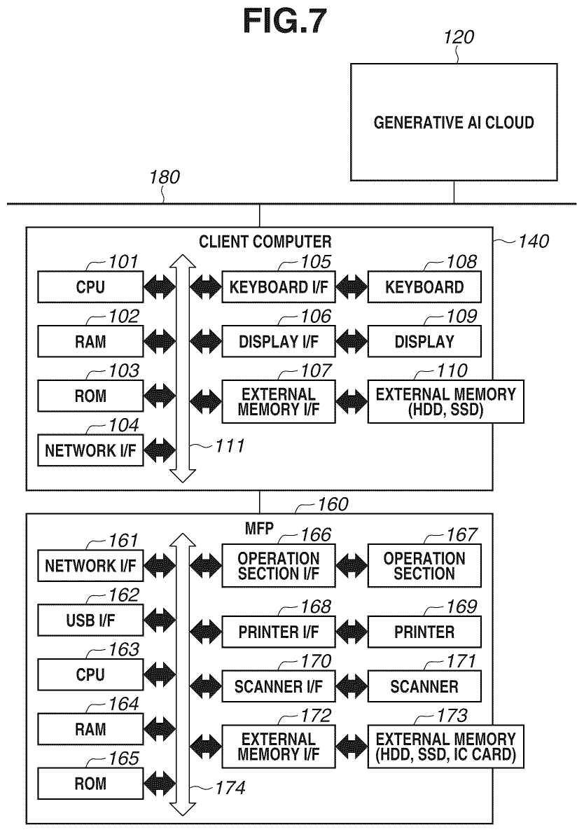

FIG. 7 is a block diagram illustrating examples of the system configuration and the hardware configuration of a support system according to the present embodiment. In FIG. 7, the MFP 160 is directly USB connected to the client computer 140. The system configuration and the hardware configuration are similar to those in FIG. 1 according to the first embodiment except for this, and therefore are not described.

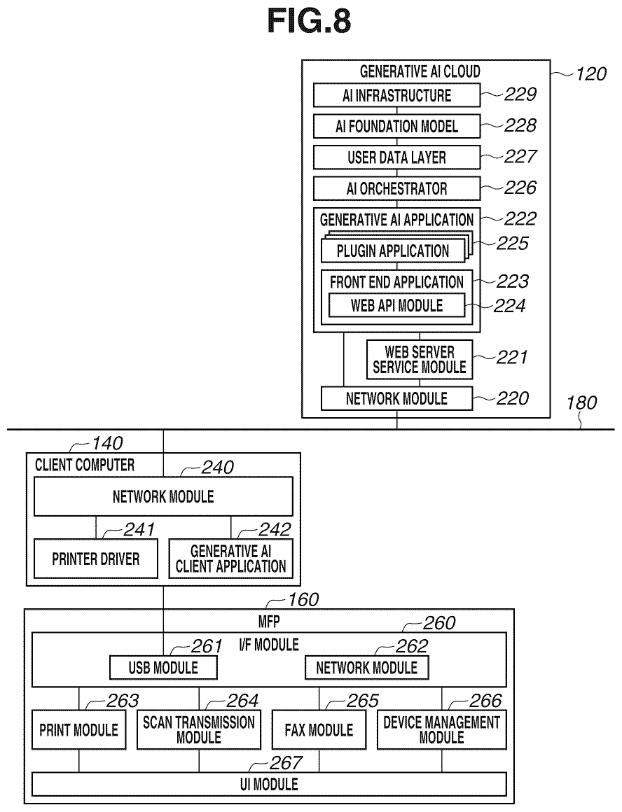

FIG. 8 is a block diagram illustrating an example of the software configuration of the support system according to the present embodiment. In FIG. 8, the MFP 160 is directly USB connected to the client computer 140 via the USB module 261. The software configuration is similar to that in FIG. 2 according to the first embodiment except for this, and therefore is not described.

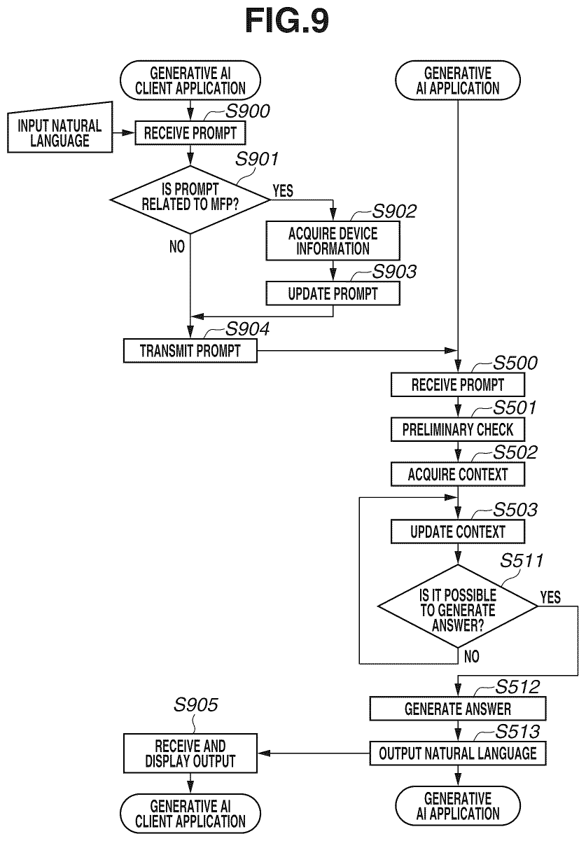

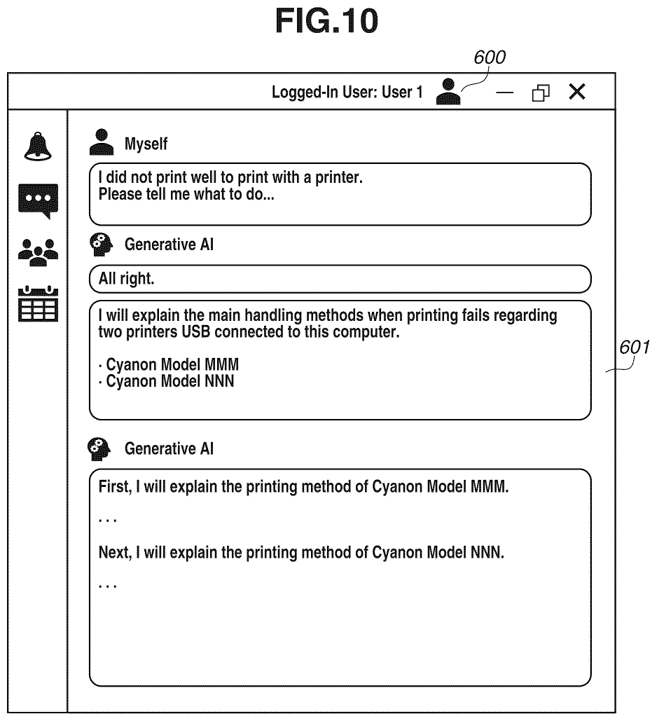

Next, with reference to FIG. 9, a description is given of processing in which the generative AI client application 242 receives a prompt regarding the MFP 160 input by the user, and an answer is generated. At the same time, with reference to FIG. 10, an example of the display of a screen of the generative AI client application 242 displayed to the user is illustrated.

FIG. 9 is a flowchart illustrating an example of a series of processes until the generative AI answers a prompt in the present embodiment. The processing in FIG. 9 is started using as a trigger the input of a prompt regarding the MFP 160 on the generative AI client application 242 by the user. FIG. 10 is a diagram illustrating an example of a screen generated by the generative AI client application 242 controlled by the CPU 101 of the client computer 140 in the present embodiment. This screen is displayed on the display 109 of the client computer 140.

The processes of steps S500 to S513 in FIG. 9 are similar to those in FIGS. 5A and 5B according to the first embodiment, and therefore are not described. The software 220 to 229 of the generative AI cloud 120 operates by being executed by the CPU 101 of the generative AI cloud 120.

In step S900, the generative AI client application 242 operating by the CPU 163 of the MFP 160 receives the prompt input by the user. In the present embodiment, an example is taken where the user inputs a prompt with a content such as “I have attempted printing using the MFP 160, but the printing has failed, so I want to perform troubleshooting”. The input prompt is not limited to a prompt regarding troubleshooting about printing. In the example of the display of the screen in FIG. 10, a logged-in username 600 is displayed, and a prompt area 601 displays the content of the prompt input by the user and an answer from the generative AI.

In step S901, the generative AI client application 242 determines whether the prompt input by the user is a prompt related to the MFP 160. The determination of whether the input prompt is a prompt related to the MFP 160 is made based on whether the prompt includes a keyword regarding the MFP 160 or a function such as printing, scanning, or the like included in the MFP 160. As a matter of course, it may be determined whether the input prompt is a prompt related to the MFP 160, using another method. If it is determined that the prompt is related to the MFP 160 (YES in step S901), the processing proceeds to step S902. If it is determined that the prompt is not related to the MFP 160 (NO in step S901), the processing proceeds to step S904.

In step S902, the generative AI client application 242 acquires device information including the official names of MFPs 160 USB connected to the client computer 140. To acquire the device information regarding the MFPs 160, for example, bidirectional printer communication (bidirectional communication) provided by the Windows (registered trademark) operating system or the like is used. Alternatively, Printer Job Language (PJL) or the like may be used.

In step S903, the generative AI client application 242 updates the prompt by adding the device information regarding the MFPs 160 acquired in step S902 to the prompt. In the example of the display of the screen in FIG. 10, the prompt area 601 displays the content of the prompt updated by adding the device information regarding the MFPs 160 acquired in step S902.

In step S904, the generative AI client application 242 transmits the prompt to the generative AI cloud 120 via the network module 240. The generative AI application 222 operating on the generative AI cloud 120 receives the prompt transmitted from the generative AI client application 242 and performs the processes of steps S500 to S513, thereby continuously repeating the inference by the LLM.

In step S513, the generative AI application 222 transmits the generated final response to the generative AI client application 242.

In step S905, the generative AI client application 242 receives the final response from the generative AI application 222 and displays the final response on the display 109 of the client computer 140. In the example of the display of the screen in FIG. 10, the prompt area 601 displays an answer regarding MFPs 160 USB connected to the client computer 140 as the final response from the generative AI application 222.

The display rule of the MFPs 160 in the answer displayed in the prompt area 601 may also be dynamically controlled. For example, the display order may be changed to the descending order of the use frequency of each device, or the descending order of the number of questions to the generative AI application 222. As illustrated in FIG. 6 in the first embodiment, option buttons for a plurality of candidate devices may be displayed, and an answer regarding a device corresponding to a button selected by the user may be displayed. A configuration may be employed in which, as described above, for example, if a device about which the user is asking a question is clear, or if there are few candidates, an answer is displayed without displaying options.

Alternatively, a configuration may be employed in which in step S903, the generative AI client application 242 treats the device information acquired in step S902 as a context, and in step S904, the generative AI client application 242 transmits the context and the prompt input by the user in step S900 to the generative AI cloud 120.

In this case, in step S500, the generative AI application 222 receives the prompt and the context, and an answer is ultimately generated based on the prompt and the context.

By the above processing, even if MFPs 160 are not connected to the network 180, the generative AI client application 242 can acquire device information regarding MFPs 160 directly connected to the client computer 140. Consequently, the generative AI client application 242 identifies a device and inputs information based on the device information regarding the identified device to the LLM, thereby causing the LLM to generate an answer. As a result, without inputting the official name of the target device, the user can obtain an appropriate answer equivalent to that in a case where the official name of the target device is input.

In the second embodiment, the present disclosure can exert an effect not only on a device but also on a service similarly to the first embodiment. Without inputting not only the official name but also natural language input that allows the identification of the device as the target, the user can obtain an appropriate answer equivalent to that in a case where the natural language that allows the identification of the device as the target is input.

### Third Embodiment

In the first and second embodiments, examples have been illustrated where the generative AI client application 242 operates on the client computer 140, and an answer is generated. In a third embodiment, an example is illustrated where the generative AI client application 242 operates on the MFP 160 and acquires information regarding a service as a target in response to a prompt regarding a cloud service with which the MFP 160 cooperates, whereby an answer is generated.

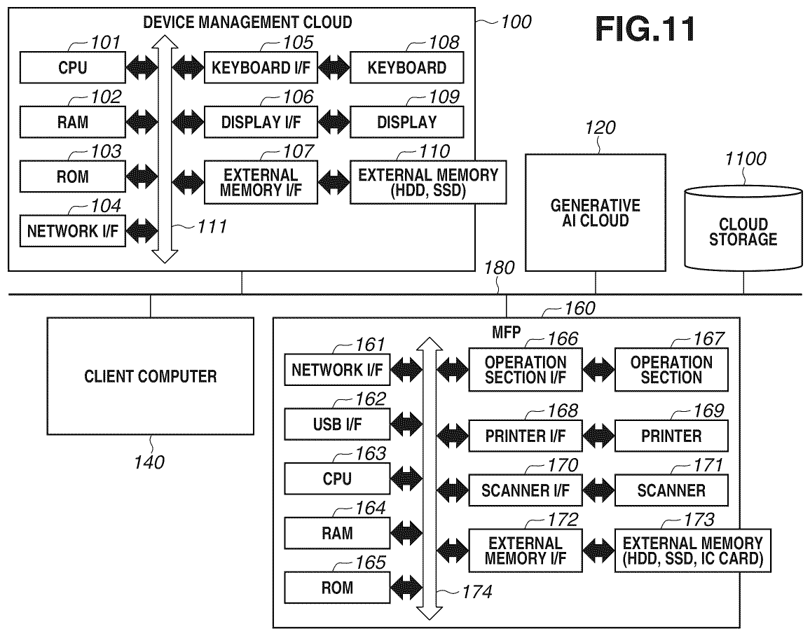

FIG. 11 is a block diagram illustrating examples of the system configuration and the hardware configuration of a support system according to the present embodiment. The support system includes a device management cloud 100, a generative AI cloud 120, cloud storage 1100, a client computer 140, and an MFP 160 that are connected together via a network 180.

The configurations of general-purpose computers that achieve the device management cloud 100, the generative AI cloud 120, and the cloud storage 1100 are achieved using hardware resources supplied on demand by a virtualization technique. The hardware configuration of the cloud storage 1100 is similar to that of the device management cloud 100 according to the first embodiment, and therefore is not described. The system configuration and the hardware configuration are similar to those in FIG. 1 according to the first embodiment except for this, and therefore are not described.

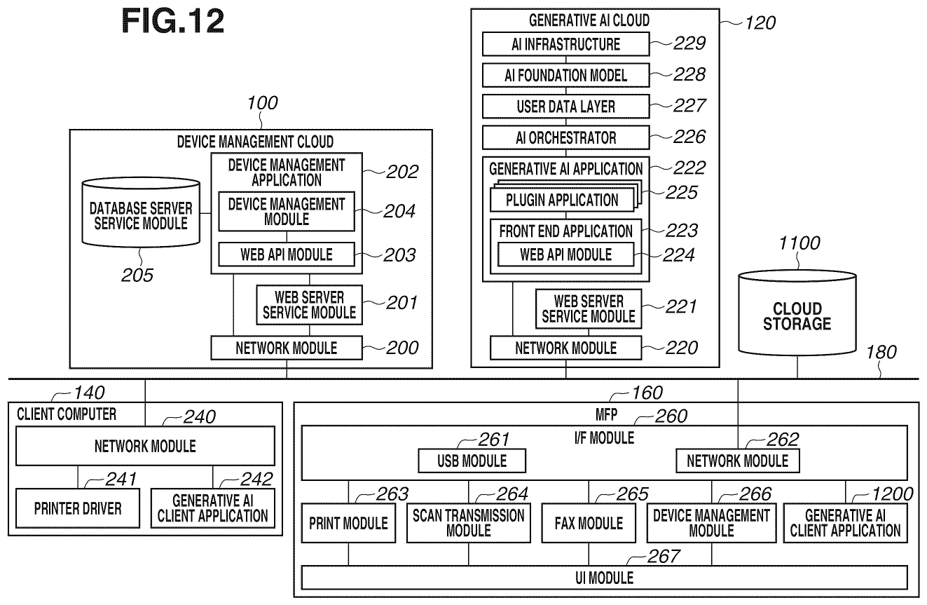

FIG. 12 is a block diagram illustrating an example of the software configuration of the support system according to the present embodiment.

The cloud storage 1100 manages a file in the cloud computing environment and stores and extracts a file according to a request from another module. When print or scan transmission is performed, the MFP 160 accesses the cloud storage 1100 and cooperates with the cloud storage 1100.

In the device management cloud 100, the device management module 204 acquires information regarding the cloud storage 1100 with which the MFP 160 cooperates in addition to the functions in the first embodiment. The acquired information regarding the cloud storage 1100 is stored in a cooperation service management table 1300 and a device-cooperation service management table 1301 in the database server service module 205. The device management module 204 also acquires the information from the cooperation service management table 1300 or the device-cooperation service management table 1301 as needed.

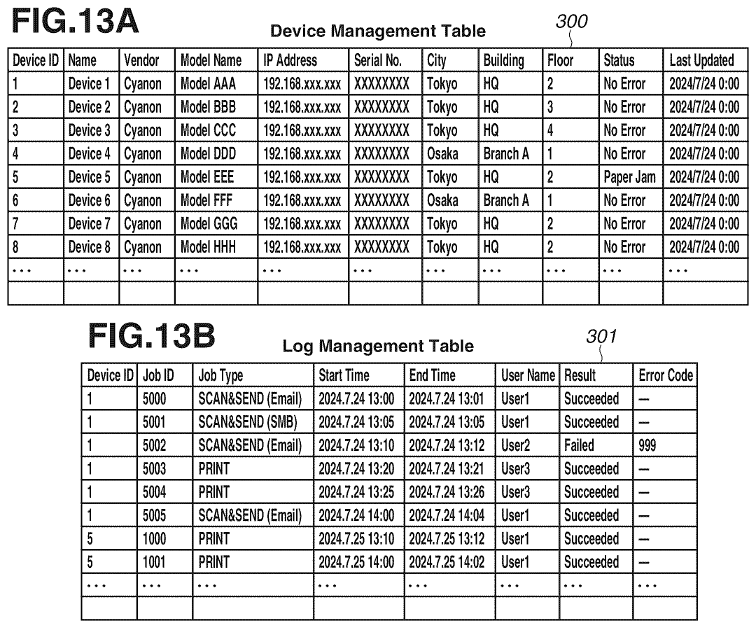

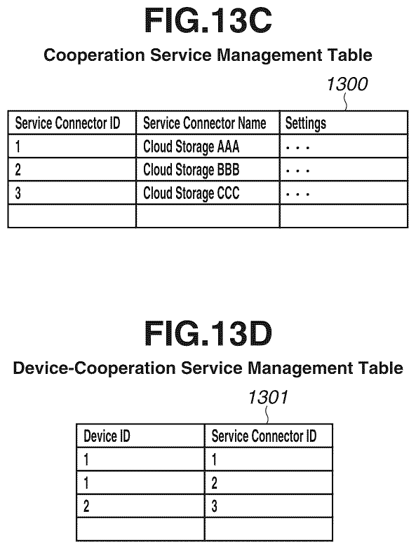

FIGS. 13A to 13D illustrate examples of table configurations in the database server service module 205 according to the present embodiment. FIGS. 13A to 13D illustrate a device management table 300, a log management table 301, a cooperation service management table 1300, and a device-cooperation service management table 1301, respectively. The table configurations in FIGS. 13A to 13D are merely examples, and table configurations different from these examples may be employed. The device management table 300 and the log management table 301 are similar to those in FIGS. 3A and 3B, and therefore are not described.

The cooperation service management table 1300 is a table that manages information regarding cloud storage 1100 as cooperation partners that can be used by the MFPs 160 managed by the device management application 202. For example, the information managed in the cooperation service management table 1300 is a cooperation service identifier (Service Connector ID), a cooperation service name (Service Connector Name), various settings (Settings), and the like.

The cooperation service identifier (Service Connector ID) is an identifier uniquely identifying the cooperation partner cloud storage 1100 that can be used by the MFPs 160. The various settings (Settings) are setting information such as authentication information required for the MFPs 160 to access the cloud storage 1100, and the like.

The device-cooperation service management table 1301 is a table that manages correspondence information indicating which MFP 160 can cooperate with which cloud storage 1100. For example, the information managed in the device-cooperation service management table 1301 is a device identifier (Device ID), a cooperation service identifier (Service Connector ID), and the like. The information may be managed by associating a plurality of cooperation service identifiers with a single device identifier, or may be managed by associating a plurality of device identifiers with a single cooperation service identifier.

In the MFP 160, a generative AI client application 1200 transmits an HTTP request message to the generative AI cloud 120 and receives an HTTP response message from the generative AI cloud 120 via the network module 262. The HTTP response message received from the generative AI cloud 120 by the MFP 160 is displayed on the operation section 167. The MFP 160 accesses the generative AI cloud 120 through the generative AI client application 1200. The software configuration is similar to that in FIG. 2 according to the first embodiment except for this, and therefore is not described.

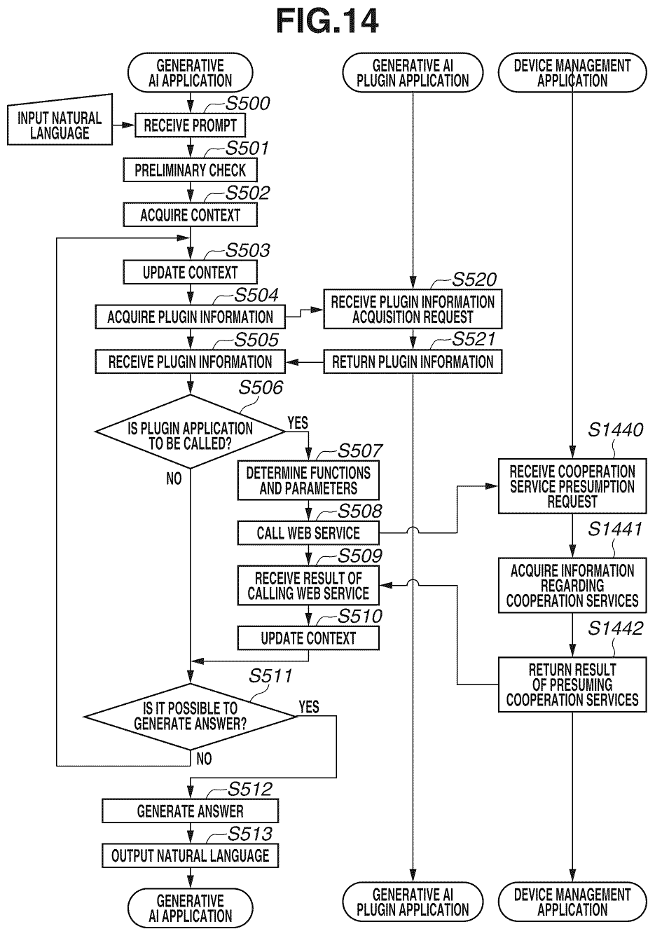

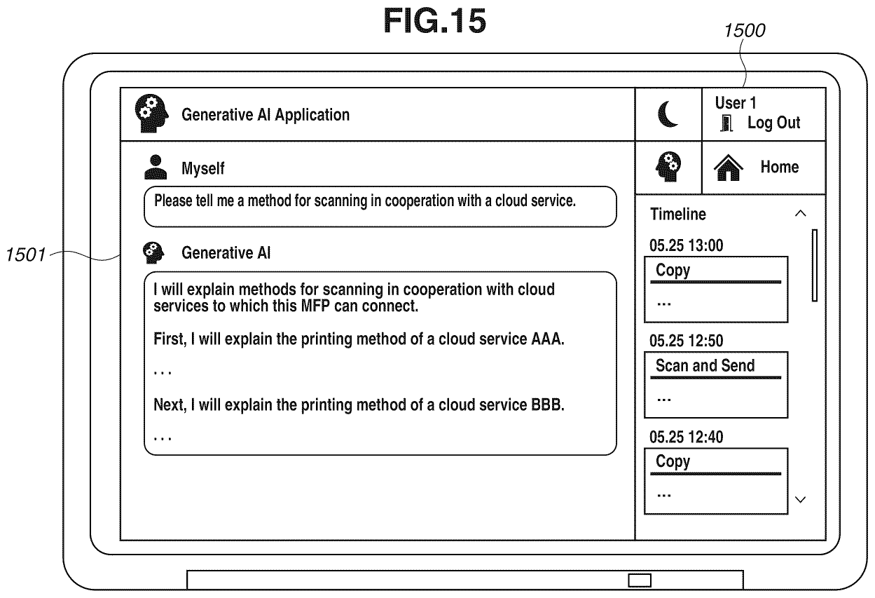

Next, with reference to FIG. 14, a description is given of processing in which the generative AI cloud 120 receives a prompt regarding the MFP 160 input by the user and answers the prompt. At the same time, with reference to FIG. 15, an example of the display of a screen of the generative AI client application 1200 displayed to the user is illustrated.

FIG. 14 is a flowchart illustrating an example of a series of processes until the generative AI answers a prompt in the present embodiment. The processing in FIG. 14 is started using as a trigger the input of a prompt regarding a service of the cloud storage 1100 with which the MFP 160 cooperates on the generative AI client application 1200 by the user. FIG. 15 is a diagram illustrating an example of a screen generated by the generative AI client application 1200 controlled by the CPU 163 of the MFP 160 in the present embodiment. This screen is displayed on the operation section 167 of the MFP 160.

The processes of steps S500 to S513 in FIG. 14 are similar to those in FIGS. 5A and 5B according to the first embodiment, and therefore are not described. The software 260 to 267 and 1200 of the MFP 160 operates by being executed by the CPU 163 of the MFP 160.

In step S500, the front-end application 223 of the generative AI application 222 operating on the generative AI cloud 120 receives the prompt from the generative AI client application 1200 operating on the MFP 160. That is, the prompt input by the user is transmitted from the generative AI client application 1200 to the front-end application 223.

In the present embodiment, an example is taken where the user inputs a prompt with a content such as “I want to know a method for scanning in cooperation with the cloud storage 1100” on the MFP 160 without specifying the official name of a service of the cloud storage 1100 on the prompt. The cloud storage 1100 is a service that cooperates with the MFP 160. The input prompt is not limited to a prompt regarding a method for scanning in cooperation with the cloud storage 1100.

In the example of the display of the screen in FIG. 15, a logged-in username 1500 is displayed, and a prompt area 1501 displays the content of the prompt input by the user.

In step S508, if the AI orchestrator 226 calls a web service, then in step S1440, the web service is called, whereby the device management application 202 of the device management cloud 100 receives a cooperation service presumption request. Then, in step S1441, the device management application 202 acquires information stored in the database server service module 205 and regarding cooperation partner cloud storage 1100 that can be used by the MFP 160.

The information regarding the cooperation partner cloud storage 1100 that can be used by the MFP 160 is acquired from the information stored in the cooperation service management table 1300 and the device-cooperation service management table 1301 in the database server service module 205.

In step S1442, the device management application 202 returns the information regarding the cooperation partner cloud storage 1100 for the MFP 160 acquired in step S1441 to the AI orchestrator 226.

In step S509, the AI orchestrator 226 receives the information regarding the cooperation partner cloud storage 1100 for the MFP 160 returned from the device management cloud 100 in step S1442. Then, the generative AI application 222 performs the processes of step S509 and subsequent steps, thereby continuously repeating the inference by the LLM. In step S512, the generative AI application 222 generates the final response. In step S513, the generative AI application 222 transmits the final response to the generative AI client application 1200. In the example of the display of the screen in FIG. 15, the prompt area 1501 displays an answer regarding the cooperation partner cloud storage 1100 that can be used by the MFP 160, which is the final response from the generative AI application 222.

By the above processing, even in a case where the generative AI client application 1200 operates on the MFP 160, information regarding a service as a target is acquired, and an answer is created based on a prompt to which the acquired information regarding the service is added. As a result, without inputting the official name of a cloud service with which the MFP 160 cooperates as a target, the user can obtain an appropriate answer equivalent to that in a case where the official name is input.

### Other Embodiments

The present disclosure can also be achieved by the process of supplying a program for achieving one or more functions of the above embodiments to a system or an apparatus via a network or a storage medium, and of causing one or more processors of a computer of the system or the apparatus to read and execute the program.

The present disclosure can also be achieved by a circuit (e.g., an application-specific integrated circuit (ASIC)) for achieving the one or more functions.

According to the present disclosure, a user can reduce the trouble of inputting a prompt for obtaining an answer adapted to a device as a target from generative AI.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-176191, filed Oct. 7, 2024, which is hereby incorporated by reference herein in its entirety.

What is claimed is:

1. An information processing apparatus comprising:
one or more memories storing one or more programs;
one or more processors that, upon execution of the one or more programs, operates as:
a receiving unit configured to receive a prompt from a user, the received prompt being natural language;
an acquisition unit configured to acquire, from a cloud service, device information regarding devices corresponding to an organization to which the user belongs; and
a display unit configured to display an answer generated by a language model based on the received prompt and the acquired device information on a display section.

2. The information processing apparatus according to claim 1,
wherein the display unit displays a plurality of options including the devices in ascending order of a distance between the information processing apparatus and each device on the display section,
wherein the receiving unit further receives selection of a device according to selection from the options by the user, and
wherein the display unit displays an answer generated by the language model based on device information regarding a device corresponding to the selected option on the display section.

3. The information processing apparatus according to claim 1,
wherein the display unit displays a plurality of options including the devices according to priorities set by the user on the display section,
wherein the receiving unit further receives selection of a device according to selection from the options by the user, and
wherein the display unit displays an answer generated by the language model based on device information regarding a device corresponding to the selected option on the display section.

4. The information processing apparatus according to claim 1,
wherein the display unit displays a plurality of options including the devices in descending order of a use frequency of each device on the display section,
wherein the receiving unit further receives selection of a device according to selection from the options by the user, and
wherein the display unit displays an answer generated by the language model based on device information regarding a device corresponding to the selected option on the display section.

5. The information processing apparatus according to claim 1,
wherein the display unit displays a plurality of options including the devices in descending order of a number of inquiries made about each device on the display section,
wherein the receiving unit further receives selection of a device according to selection from the options by the user, and
wherein the display unit displays an answer generated by the language model based on device information regarding a device corresponding to the selected option on the display section.

6. The information processing apparatus according to claim 1,
wherein the acquisition unit acquires, according to the reception of the prompt by the receiving unit, the device information without receiving an instruction to acquire the device information from the user.

7. The information processing apparatus according to claim 1,
wherein the prompt is a question about troubleshooting regarding the devices, and
wherein the answer is an answer indicating processing that can be executed by the devices corresponding to the acquired device information, and is an answer generated by the language model to the question about the troubleshooting.

8. The information processing apparatus according to claim 1, wherein the organization is a company to which the user belongs.

9. The information processing apparatus according to claim 1, wherein the answer includes text.

10. The information processing apparatus according to claim 9,
wherein the answer further includes options for devices,
wherein the receiving unit further receives selection of a device according to selection from the options by the user, and
wherein the display unit displays an answer generated by the language model based on device information regarding a device corresponding to the selected option on the display section.

11. The information processing apparatus according to claim 1, further comprising:
a transmission unit that transmits the received prompt and the acquired device information to a server on which the language model is stored; and
a reception unit that receives the answer generated according to the transmission of the received prompt and the acquired device information,
wherein the language model functions by a server.

12. The information processing apparatus according to claim 1, wherein the devices are multifunction peripherals.

13. The information processing apparatus according to claim 1, wherein the display unit displays an answer generated by the language model based on the received prompt and the acquired device information on a display section of the devices.

14. A non-transitory computer-readable storage medium for storing a program causing a computer to perform an information processing method, the method comprising:
receiving a prompt from a user, the received prompt being natural language;
acquiring, from a cloud service, device information regarding devices corresponding to an organization to which the user belongs; and
displaying an answer generated by a language model based on the received prompt and the acquired device information on a display section.

15. The storage medium according to claim 14,
wherein the displaying displays a plurality of options including the devices in ascending order of a distance between an information processing apparatus that executes the program and each device on the display section,
wherein the receiving further receives selection of a device according to selection from the options by the user, and
wherein the displaying displays an answer generated by the language model based on device information regarding a device corresponding to the selected option on the display section.

16. The storage medium according to claim 14,
wherein the displaying displays a plurality of options including the devices according to priorities set by the user on the display section,
wherein the receiving further receives selection of a device according to selection from the options by the user, and
wherein the displaying displays an answer generated by the language model based on device information regarding a device corresponding to the selected option on the display section.

17. The storage medium according to claim 14,
wherein the displaying displays a plurality of options including the devices in descending order of a use frequency of each device on the display section,
wherein the receiving further receives selection of a device according to selection from the options by the user, and
wherein the displaying displays an answer generated by the language model based on device information regarding a device corresponding to the selected option on the display section.

18. The storage medium according to claim 14,
wherein the displaying displays a plurality of options including the devices in descending order of a number of inquiries made about each device on the display section,
wherein the receiving further receives selection of a device according to selection from the options by the user, and
wherein the displaying displays an answer generated by the language model based on device information regarding a device corresponding to the selected option on the display section.

19. The storage medium according to claim 14,
wherein the acquiring acquires, according to the reception of the prompt, the device information without receiving an instruction to acquire the device information from the user.

20. The storage medium according to claim 14,
wherein the prompt is a question about troubleshooting regarding the devices, and
wherein the answer is an answer indicating processing that can be executed by the devices corresponding to the acquired device information, and is an answer generated by the language model to the question about the troubleshooting.

21. The storage medium according to claim 14, wherein the organization is a company to which the user belongs.

22. The storage medium according to claim 14, wherein the answer includes text.

23. The storage medium according to claim 22,
wherein the answer further includes options for devices,
wherein the receiving further receives selection of a device according to selection from the options by the user, and
wherein the displaying displays an answer generated by the language model based on device information regarding a device corresponding to the selected option on the display section.

24. The storage medium according to claim 14, the method further comprising:
transmitting the received prompt and the acquired device information to a server on which the language model is stored; and
receiving the answer generated according to the transmission of the received prompt and the acquired device information,
wherein the language model functions by a server.

25. The storage medium according to claim 14, wherein the devices are multifunction peripherals.

26. The storage medium according to claim 14, wherein the displaying displays an answer generated by the language model based on the received prompt and the acquired device information on a display section of the devices.

27. An information processing method comprising:
receiving a prompt from a user, the received prompt being natural language;
acquiring, from a cloud service, device information regarding devices corresponding to an organization to which the user belongs; and
displaying an answer generated by a language model based on the received prompt and the acquired device information on a display section.
